(19) United States
(12) Patent Application Publication
(10) Pub. No.: US 2015/0348017 A1
(43) Pub. Date: Dec. 3, 2015

(54) METHOD FOR INTEGRATING CRYPTOCURRENCY TRANSFER ON A SOCIAL NETWORK INTERFACE

(71) Applicant: Jonathan Allmen, Gilroy, CA (US)

(72) Inventor: Jonathan Allmen, Gilroy, CA (US)

(21) Appl. No.: 14/295,279

(22) Filed: Jun. 3, 2014

(51) Int. Cl. G06Q 20/36; G06Q 20/40

(52) U.S. Cl. CPC G06Q 20/367; G06Q 20/401; G06Q 2220/00

(57) ABSTRACT

A method for transferring crypto currency between users of a social network is disclosed. The method enables users of an internet capable machine, who encounter each other on a social network or other internet based communication platform to securely deposit, withdraw, send, receive or transfer definable amounts cryptocurrency between each other using an interface which integrates features of the social network using valid cryptocurrency wallets. The interactive component for initiating the cryptocurrency transfer can appear within any content seen by, interacted with and/or created by a user including both private and public interfaces. The method may be used to transact between any number of parties any number of transactions. The method includes means for authorizing, encrypting and/or confirming aspects of the cryptocurrency transaction and protecting the interest of all involved parties; as well as the issuance of cryptocurrency transaction fees over a social network or internet based communication platform.

### BACKGROUND OF THE INVENTION

A major innovation in transaction and financial technology is the development of Crypto-Digital Financial Instruments (hereinafter referred to as “CDFI). These are currencies, assets, commodities, derivatives or debts, etc., which are secured and verifiable utilizing various encryption schemes, primarily public/private encryption. Many of these systems make use of recent software innovations, including decentralized, networked or public ledgers, open source protocols and automated contracts. Most famous of these asset protocols is “Bitcoin”, however many others exist. These developments have, on the one hand, created transaction types that traditional payment methods are not well suited for and on the other hand, have created an opportunity for innovation in the payment and transaction industry.

More particularly, there is a need for a monetary system that solves for providing a method of settlement as between buyers and sellers of CDFI. Specifically, reducing counter-party risk involved in performing CDFI transactions where, for example, one transaction type may be irreversible and the other is reversible. Also, providing for the transaction to be (near) instant and secure while simultaneously having the settlement to be delayed, thereby solving the problem of transactions using payment methods which by way of example only, operates at different time scales.

Furthermore, a method is needed which allows for these new types of credit-based payments to be tied to mathematically verifiable events, wherein said events are a form of completion criteria. This allows for automated and scalable settlement protocols, which require no arbitrary judgments. Lastly, there is a need for a method that describes automatically issued digital contracts that may be automatically enforced, resulting in reduced fraud and counter-party risk when dealing with all different types of CDFI. Additionally, there is a need for a consumer based ecommerce that will stem from user created content utilizing social networks as the prime environment to facilitate the adoption of an online user-to-user economy. For this transition to occur there needs to be an accessible, safe, reliable and easy methodology which is provided by the present invention.

### SUMMARY OF THE INVENTION

A business method and system are disclosed comprising a software/computer/firmware module that creates contract/credit certificates with verifiable and objective terms based on a trade request between two or more parties. The module of the present invention also monitors CDFI networks, to verify performance of the expected terms and notifies a credit issuing party as to the status (eg. complete/not complete) of the relevant contract/credit certificate.

The module, by use of encryption techniques or cryptography, ensures that the credit issued is only issued once while verifying credit-certificates. The disclosed business method and system allows for credit issuing bodies to provide payment guarantees that may be claimed only upon meeting objectively/mathematically verifiable terms on CDFI networks. Lastly, the invention provides a business method for using CDFI networks to issue digital credit certificates that cannot be double-spent.

### BRIEF DESCRIPTION OF THE DRAWINGS

Further objects and advantages of the present invention will become apparent as the following description of the illustrative embodiments takes place, in which:

FIG. 1 is a system block diagram illustrating integrating crypto currency transfer on an internet based communications service according to one embodiment of the present invention;

FIG. 2 is a system block diagram illustrating the use of a middle wallet between a user A and a user B by a crypto currency transfer occurring over a social network;

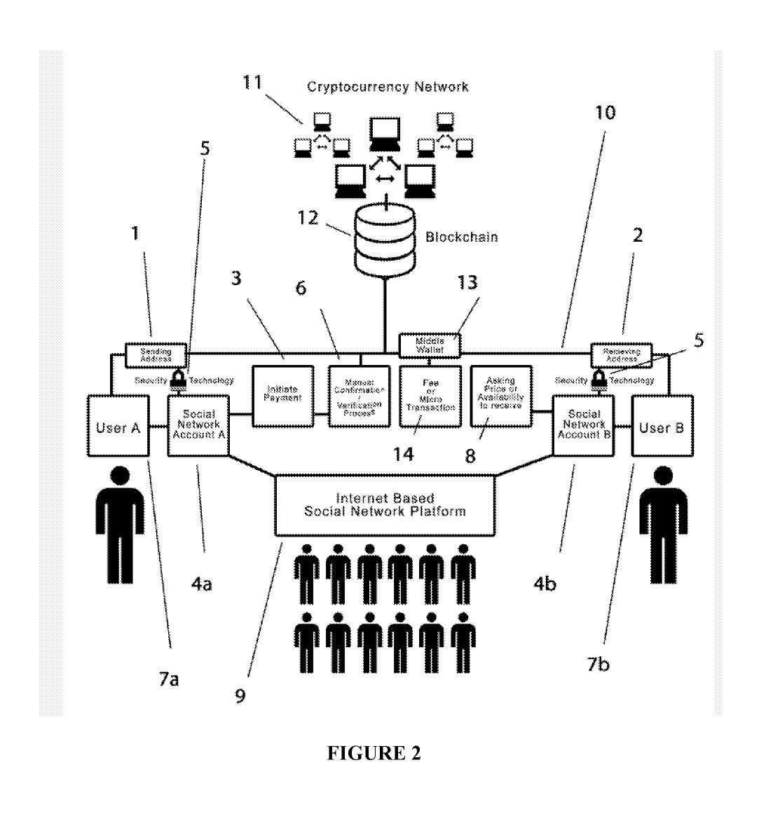

FIG. 3 is a system block diagram illustrating the interaction of a middle wallet between participants;

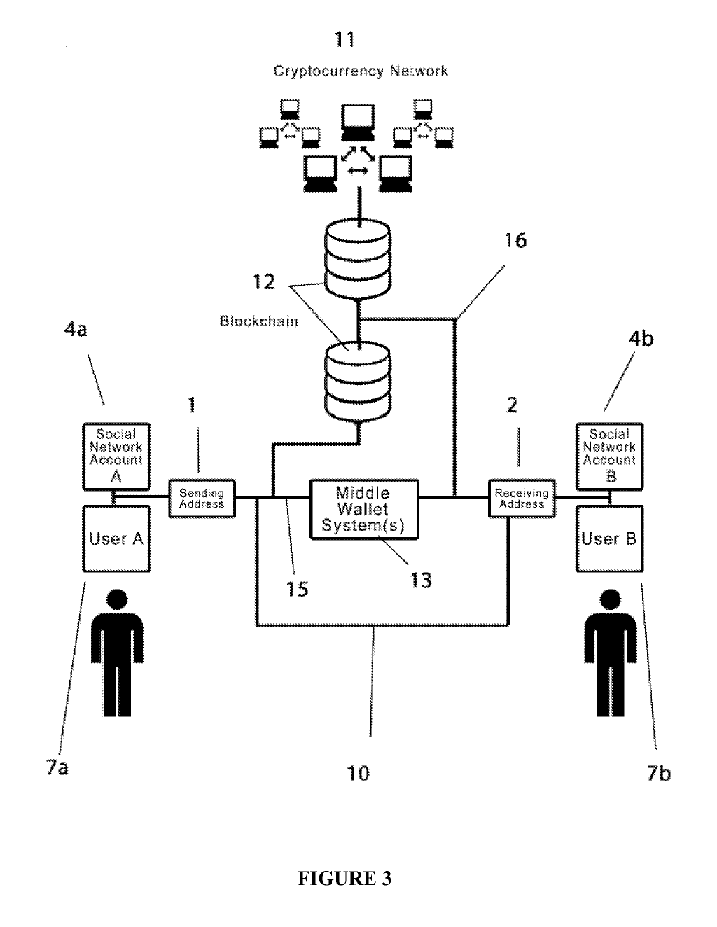

FIG. 4 is a system block diagram illustrating crypto currency on a social network and the methods and elements used for interaction and interface placement; and

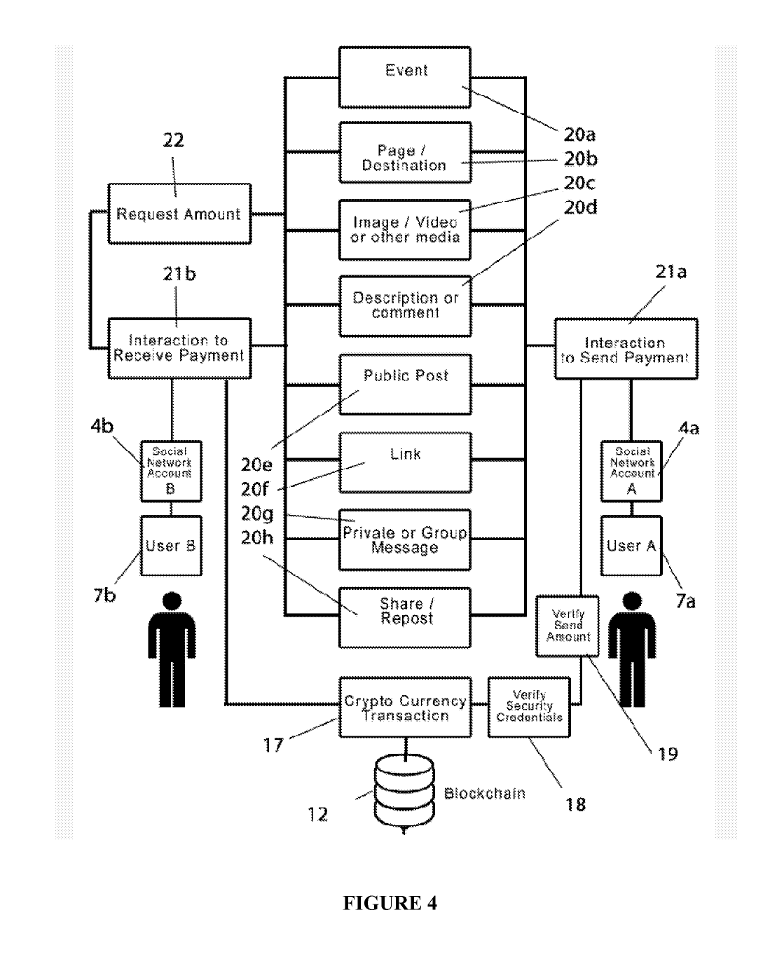

FIG. 5 is a system block diagram illustrating security measures for crypto currency on a social network or internet based communication service.

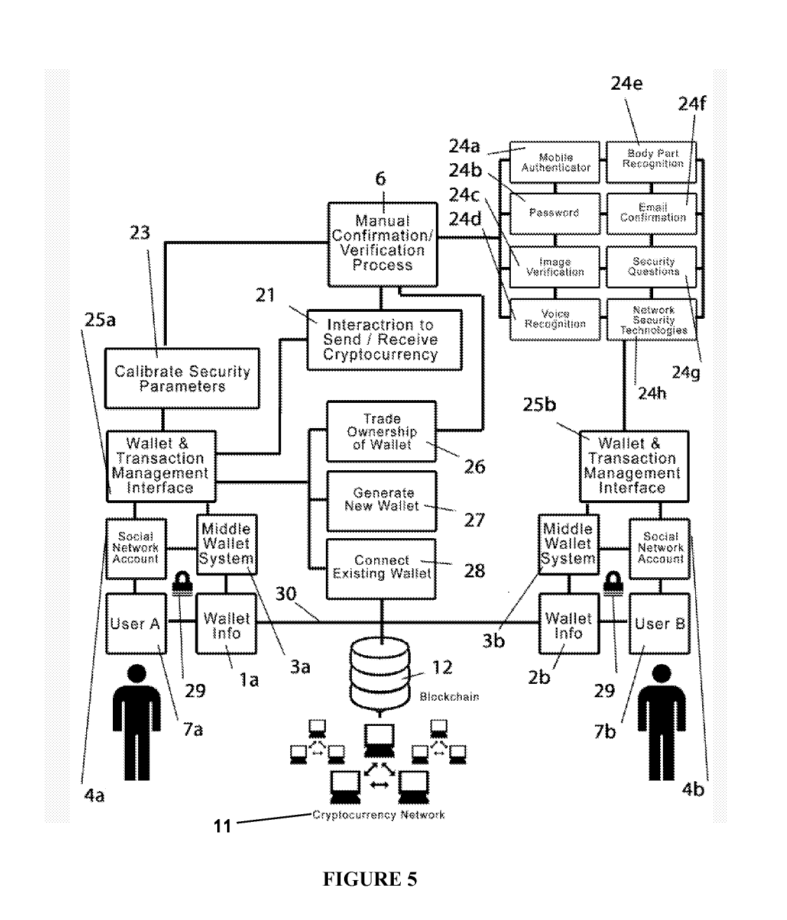

### DESCRIPTION OF A PREFERRED EMBODIMENT

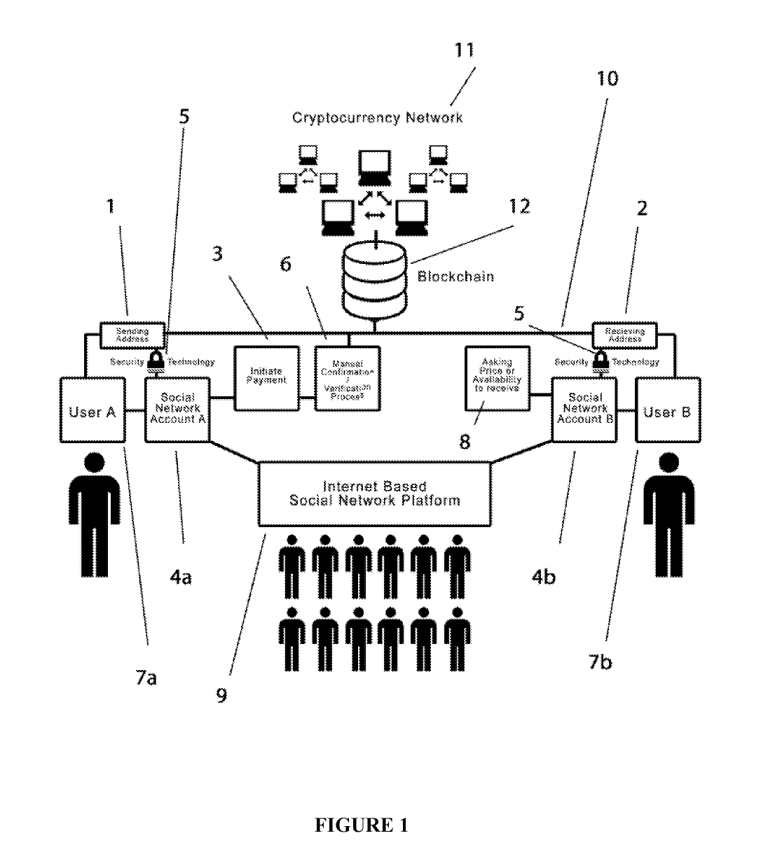

Referring now to FIG. 1 there is shown a system block diagram illustrating integrating crypto currency transfer on an internet based communications service according to one embodiment of the present invention. User A 7a joins a social network by creating an account 4a which they can log in to using a password, user name, or sometimes an email address or other private credentials predefined by the social network 9 which make access and utilization of the account unique to the user. The user can send messages, interact with others or share content in a variety of ways including but not limited to pictures, video and language. The methodology of the patent introduces a unique feature for transferring crypto currency over the social network 10 or internet based communication service which allows two or more individuals to agree upon, directly or indirectly, to make a transaction in crypto currency over a familiar platform such as a social network or other internet based communication service. 10

Crypto currency, a digital medium of exchange, fundamentally incorporates principles of automated cryptography to implement a distributed, decentralized and secure information economy. Within crypto currency systems, the safety, integrity, and balance of all ledgers is ensured by a single computer or network of computers 11 actively verifying all transactions occurring in a predetermined amount of time known as a block. The sequence of transaction events can therefore be divided into a block chain 12, an intentionally irreversible record of all transaction events in occurrence.

In order for a crypto currency transaction 10 to occur, two users must each be in possession of a digital wallet containing a key code which represents either a send 1 or receiving 2 address unique to the individual wallet. The private sending address can then be utilized on an internet connected device to initiate a payment 3 or other transaction to a public receiving address 2. From the user's perspective, paying with crypto currency in essence is not that much different from other payment mechanisms: value is transferred between payer and payee.

The methodology of the patent encompasses the integration of the private sending address 1 and public receiving address 2 of a crypto currency wallet and therein the wallet itself with a social network account 4a. Security measures 5 to prevent: theft, breach of privacy or other hostile infiltration of the wallet information and addresses can be introduced during the wallet and social network platform integration process 5 as well as during a manual confirmation and/or transaction verification process 6. Any combination of security measures 5 shall be chosen by, presented to, or otherwise disabled and/or not utilized, at predefined preference, by the user 4a4b of the social network 9 to authenticate 6 an initiated crypto currency transaction 3 or validate the user's 4a4b adjustment to parameters or settings of the appended crypto currency wallet information 12 on the social network account 4a4b.

The first user, User A 7a, shall initiate the transfer of a specified payment amount 3 (specified by the recipient 7b or specified by the sender 7a) directly to another member, User B, 7b of the social networking platform via an interaction, specified as, but not limited to a button, input field, menu, meter, scannable or other utility for initiating a payment. 3 The interaction 3 can appear on a variety of locations within the social network including but not limited to a profile, channel, any content hosted by, created, adjusted, repeated, shared, uploaded, downloaded or otherwise presented by or connected to the recipient user, User B 7b or their appended social network account 4b on the social network platform. 9

Upon completing or otherwise disabling and/or not utilizing a crypto currency transaction manual confirmation or verification process 6, the predefined volume of crypto currency is transferred from the private sending address 1 of User A 7a to the receiving address 2 of User B 7b, a transaction 10 that is facilitated within the block chain 12 and automatically validated by the crypto currency network. 11 A non-reversible action, except by the input of User B 7b after the completion of the transaction 10; the predefined amount or subdivision of crypto currency shall leave from the wallet 1 of User A 7a and travel to the destination of User B's 7b wallet 2; regardless of the intention to purchase, donate, gift, trade or otherwise exchange crypto currency.

Independently, User B 7b can utilize similar or differing security measures 5 provided during the manual confirmation/verification process 6 to authenticate the details of their own wallet's 2 relation to or adjustable parameters within the social networking platform 4b9; including the sending, receiving, deposit or withdrawal of crypto currency obtained from other users of the social network 9 or other users of the same crypto currency network 11. User B 7b can also attach an asking price 8 component to a content piece during participation of any social network feature which innately expresses availability to receive crypto currency and/or a specified amount of crypto currency. 8 The component links a receiving address, 2 whether visible or underlying the interface, and a predefined amount of crypto currency which allows User A 7a, the sender, to fulfill the total or only part of the asking price by initiating a crypto currency payment 3 upon interacting with the component. 8

Both User A 7a and User B 7b can send or receive crypto currency to each other using the aforementioned methodology. At the base level all that is required to participate on either end of the crypto currency transaction is a digital wallet 12 holding valid addresses within the block chain 12 of the crypto currency network 11 and a unique account on the social network platform 4a4b to which the wallet is appended. 5 Therefore, one user can send any distinguishable amount or subdivision of crypto currency 10 to any number of recipients 2 and any number of senders 1 can transact to a single recipient address. 2 The patent therefore serves to elaborate on the methodology utilized in sending an identical amount of crypto currency to a multitude of addresses 12 with a single action by adding multiple recipients 2 to a list, group, collective or boolean. The reciprocal of requesting payment 8 in the same manner is also claimed by the patent, in which a user of the network 7b can define a list of other users 7a and then present them with a component 8, incorporating a valid receiving address 2, which serves as a request to make payment or to send crypto currency 10 to the receiving address. 2

A third, middle wallet 13 can be introduced to serve as a temporary account between the two participants 7a7b of the crypto currency exchange 10. The middle wallet 13 can exist on the same block chain 12 and crypto currency network 11 or it can exist as a separate form of crypto currency, money, or other economic exchange not related to the crypto currency network 11 of the original sender. 7a14a. The interface on the social network 4a4b9 can indicate that User A 7a is directing crypto currency toward the wallet 2 of User B 7b; however the insertion of a receiving wallet address for a third, middle wallet 13 will prevent the transaction from traveling directly from User A 7a1 to User B 7b2. The middle wallet 13 first acts as a safeguard. Holding transactions which may fit criteria for a suspicious behavior category, consist of a high volume or other predefined parameters 56 for flagging the transaction as temporarily withheld from reaching the wallet address 2 of the recipient, User B 7b.

The middle wallet 13 shall be integrated with a program or manual operator which pauses to send the crypto currency to the recipient(s) 2 until certain predefined conditions are met: transaction verification, identity authorization, or other form of approval 6 is provided by any means of confirmation by the involved party, parties and/or any third party. 7a7b1391112. The middle wallet 13 can be managed to return payments to the original sender 17a if the requirements of the transaction are not fulfilled by the recipient 27b within or not regarding predetermined time frames for delivery or completion. The method shall include reporting the success of the transaction between the sender 17a and the middle wallet 13; provision of notification to the sender 7a14a and/or recipient 7b24b, adding the sender's account name, amount sent, other identifying information, or otherwise posting the valid transaction to a list which can be reviewable by a user. 7a7b913

The middle wallet or third parties 139 can also deduct a transaction fee or micro transaction 14 amounting to a fixed, indexed, adjustable, variable, percentage or other type of rate from the crypto currency transaction 10. Notification to the sender 7a14a of the transaction fee 14, factoring the fee 14 into the equation for total amount to be sent and displaying the itemized price information calculated before and after the transaction fee 14 to the sender 17a4a or recipient 27b4b9 shall occur before the total amount to send or request to receive has been confirmed by either party 7a7b139. The transaction fee 14 shall be kept within the middle wallet 13 or sent to any other wallet(s) 12 in any lump sum, subdivision or exact quantity of the transaction fee(s) 14.

The middle wallet 13 can furthermore be used to aggregate a series of payments in the form of a fund raising, collection efforts or other gathering of crypto currency where the total or partial amount is sent to the recipient address′2 before or after a predetermined quantity has been met or exceeded. The middle wallet 13 can also serve to report and notify the status of the crypto currency aggregation. The middle wallet 13 can also serve as the medium of transfer wherein instead of using the block chain 12 to complete the transaction 10 by sending crypto currency to the address of the recipient 2; the middle wallet 13 itself is prepared for the recipient 7b with an arranged volume of crypto currency within or prepared to be sent to the middle wallet address 13. The login or access credentials for the middle wallet 13 are made available to the recipient 7b who can now access an amount of crypto currency greater, less than or equal to the amount originally sent by User A 7a.

User A 7a, a member of the social network 9, sends an amount of crypto currency 10 to User B 7b of the social network 9. Although the methodology encompasses a transaction 10 initiated by the sender 7a traveling directly from the sending address 1 into the wallet of the recipient 2; the methodology also includes any process wherein the transaction shall first be received 15 by a middle wallet or system of middle wallets 13; therefore, a transaction 15 between the sender's wallet 1 and the middle wallet 13 is recorded in the block chain 12 and verified by the crypto currency network 11. The crypto currency network 11 also records transactions onto the block chain 12 between the middle wallet(s) 13 themselves and/or the middle wallet 13 to the recipient's wallet 2.

The method can involve a digital and/or other process for routinely or constantly scanning the contents of the block chain 12 for the unique key code address belonging to the sender's wallet 1, the middle wallet address 13 and the volume or information encapsulated in the transaction 15. Once the activity is recognized on the block chain 12, the transaction 15 is approved as having occurred on the block chain, notification can be sent to any involved parties 7a7b139, confirming the analysis of the block chain 12 was successful and that the correct or incomplete total amount 15 was recorded as being sent from the correct sending wallet key code 1 to the middle wallet's key code 13. The volume shall now be reserved, protected, recorded, monitored, reported, moved, secured or temporarily frozen for the purpose of completing the transaction 16 between the sending wallet 1 and the receiving wallet 2 by forwarding the payment 16 to the recipient 27b4b once the predefined conditions of the exchange 151610 are met or verified by one, both parties and/or third party 7a7b139.

Any number of middle wallet addresses 13 can be inserted into the transaction process 1516 between User A 7a and User B 7b. Multiple wallets in the methodology can serve purposes for process control, management, accounting, security or record keeping in which the crypto currency travels from wallet to wallet 1312 for all intents and purposes. In example, the method serves to reduce feasibility of stealing crypto currency from a user of the social network 4a4b12. Being that the block chain 12 can be public, predators may hunt for transaction volumes 101516 and keys 1213 to ascertain user 7a7b4a4b activity which may empower the malevolent's capability to fish for security credentials. Hackers may attempt to make alterations to how the systems 13 functioning within the methodology scan and retrieve information from the block chain 12 and thus manipulate qualities of one or any parts of system whereas a middle wallet system 13 can increase the difficulty of successfully breaching the 3rd party 13 or crypto currency transaction system 1516 by not revealing phases, process elements or other aspects 13 of the crypto currency transaction to the public.

A single middle wallet, electronic database of middle wallets, physical ledger containing multiple middle wallet addresses or any other system and/or sequence of middle wallets 13 is utilized to keep track of and complete all transactions 1516 and shall be operated by a digital process, human operator or other form of procedural execution 13. The middle wallet(s) 13 chosen to facilitate the transaction between two parties 7a7b4a4b shall be: selected at random, algorithmically, based on availability, service tier, security level, chosen manually or otherwise specified to fulfill the role of interacting with the transaction 1516 between User A 7a & User B 7b.

The transaction 16 between the middle wallet 13 and User B 7b also occurs on the block chain 12. Verification of the transaction 13 having occurred may require scanning a different block within the block chain 12 than where the original sender's 1 transaction 15 occurred depending on the amount of time transpired in between the first 15 and final 16 transactions. Reporting the number of blocks between transfers 12 or providing a response involving data from the block chain 12 to User A 7a4a or User B 7b4b in the form of an authenticated invoice or any format is covered by the methodology.

The interaction to send crypto currency 21a to a recipient 7b can appear on a variety of places on the social network 20*. When taking an action on the social network to make information available to another user 20*, User B 7b can select an option, or a non-optional feature exists to include an interactive component 21b which appears adjacent to, in front, behind, within or otherwise juxtaposition to the body of information. Common locations to find the component are on events 20a, pages 20b or other destinations of the social network, near images/video/other media 20c, paired with a description or a comment 20d, on a public post or message 20e, a link 20f, a private message/group message 20g, share, repost 20h, home/profile page 20b, listing or any other form of information contributed 20* to the social network by a user or advertiser 7b7a. The component 21b may commonly appear next to another interactive component such as a button to like, share or comment.

The component 21b can be configured to display notification of and/or request a specified amount of crypto currency 22 in which User A's 7a interaction 21a with the component 21b will initiate a process to send the specific amount 17. The component 21b can also serve to request an unspecified amount of crypto currency in which User A 7a can determine the amount of crypto currency to send 19. User B 7b can also configure the component 21b to a minimum and/or maximum parameter, directing User A 7a to input the amount of crypto currency 19 but limiting the maximum or minimum quantity that can be input before confirming the transfer 18. Discounts or additional fees can be applied to any offer or request.

Furthermore, a user 7a can also set up a component 21a consisting of any attributes from the aforementioned methodology which sends a payment 17 to another user 7b for the purpose of utilizing the venue to advertise a need, request or requirement to be fulfilled. A user 7b can register, bid on, apply for or otherwise offer to oblige and fulfill the requirements of the opportunity in exchange for the crypto currency transfer 17 conditions specified by the user 7a through the component 21a.

The components 21b21a can inherit a symbol, color, detail or other attribute to indicate the type or status of request/offer. The method applies: to quickly differentiate whether the component is an offer to send 21a or receive 21b crypto currency, an indicated price for exchange of goods, commodity or service, whether it falls into a different economical category such as charitable donation, crowd fund or gift, if the status of a crowd fund reaches a certain level or the User 7b7a has paid for a special, modified listing as a marketing/exposure advantage or for any other reason. The method serves to otherwise differentiate one component 21b21a from another 21b21a for any purpose or intention.

The component 21b21a can take a variety of different forms to fit aesthetically into the user experience of the social network 4a4b. The component 21b21a can consist of a series of sub components in which one or more of the sub components function together as the initiation of a process to transfer crypto currency from one wallet to another 17. The component(s) 21a21b most commonly take the form of a clickable button or other interactive media, leading a user 7a7b directly or indirectly toward the crypto currency transfer process 17. The component 21a21b can take the form of a scan able object, using an internet connectable device to scan the object can initiate the transfer. The component 21a21b can accept input from a keyboard or other electronic device. The component 21a21b can offer an opportunity to manually enter a volume or choose from a list or menu of options. The component 21a21b can receive external stimulation such as voice or auditory activation, motion sense, touch, visual stimulus or other stimulation originating from, generated by or occurring with assistance of the user 7a7b or a representation of the user 7a7b. The component 21a21b can consist of any other form of activation which initiates a process immediately or eventually involving a transfer of crypto currency 17.

Methodology for securely making cash, money or crypto currency deposits, withdrawals or other exchange into/out of a wallet 1a2b from the interface of social network site 4a4b: Within the wallet & transaction management interface 25a25b, a user 7a7b can deposit value into the crypto currency wallets 1a2b associated with the user 7a7b & social network account 4a4b or withdraw this crypto currency to another wallet or exchange for cash value.

The methodology for encryption and decryption of crypto currency, wallet information 1a2b, transactions 30, identities 7a7b4a4b or other exchange of crypto currency information occurring between users 7a7b of a social network interface or other internet based communication platform in which the trade was initiated in conjunction with the social network/internet based communication platform where the encryption and decryption process occurs outside of the scope of the crypto currency's autonomous algorithmic encryption/decryption model itself 11: In which a second or more encryption method(s) 2924g are introduced to one or any packets of information transferring between two users of a social network or internet based communication service during the process of a crypto currency transaction 30.

The method includes the capability for users 7a7b who encounter each other on a social network 4a4b to attach wallet addresses 1a2b to the social network interface 4a25a4b25b and send crypto currency at its base level directly to each other 30 without utilizing any extra security measures outside the scope of the crypto currency model itself 1211. The sensitive private wallet keys 1a2b utilized in sending crypto currency 30 must be protected and kept secret by a series of measures Inherently, crypto currency wallets 1a2b can be encrypted with a password, phrase or other “key” which serves to authorize the sending of crypto currency from the wallet to another wallet 30. The methodology herein serves to expand upon this principle and offer more options for authorization each providing resistances and contingencies to protect against a variety of malicious attempts to obtain authorization credentials or infiltrate wallets and steal crypto currency.

A crypto currency wallet 1a2b can be created securely 27 by a user 7a7b within the interface of the social network 4a4b25a25b. The wallet is unique to that user 7a7b and is legitimately generated to function within the block chain 12, however the process for encrypting the wallet 1129 as well as the private sending addresses 1a2b are kept confidential and as standard are not revealed to the public. Interactive representations of sending addresses 21 for one wallet or any number of wallets 1a2b linked to the user 7a7b can appear on a private section 4a4b25a25b of the site and contain identifying attributes for naming, organizing, categorizing, color-coding, or otherwise specifying the appearance or text of the component 21. The components 21 can have parameters to set the total amount, calibrate specified amount, frequency or number of crypto currency transactions that can be sent 23. The component 21 can also be preset to automatically transfer crypto currency at preset dates, times or other parameters 23. The component 21 can be permanently or temporarily locked. Users 7a7b can define the criteria in which certain frequencies, volumes of crypto currency, blacklisted addresses, or other parameters 23 executed by the send address 211a2b can define a transaction into a suspicious behavior category and initiate measures to protect the owner of wallet including but not limited to temporarily freezing the transaction or transferring funds out of a compromised wallet 1a2b3a3b.

Reporting transfer status or transfer fundamentals 30 can also be an extension of the component 21 or appear within the interface in relation to the component 25a25b. The varying address components 1a2b3a3b28272621 can also have different verification methods 24* as to prevent one breach of security resulting in total losses. An existing crypto currency wallet 28, at its base level, is embedded into the social media interface 25a25b. This can be accomplished by way of uploading the wallet as a whole 28, embedding, linking or otherwise connecting one or more attributes of the wallet 1a2b into the interface of the social network account 25a25b. The method can also be as simple as copy and pasting the wallet address into a secure field of the site 25a25b and allowing users to make direct contributions to that address 1a2b or a component representing the address 21. The user can also input the wallet's send address 1a and enable their wallet's network decryption 11 through the social network interface's verification processes 25a25b24*23.

The security method for transferring crypto currency does not always involve the user interacting with the password or “key” 1a2b for the actual encryption of the wallet 11, wherein the wallet 1a2b is managed separately by a third party or automated program in which the user provides one or more verification methods 624, independent of the wallet's encryption method 11 to authorize the third party or automated program to input the wallet's encrypted sending operation 1a2b11 and transfer a specified amount of crypto currency out of the wallet 30.

The user 7a7b can choose whether or not to set parameters for the verification process 6, which processes 24*, and number of verification processes required 6 before successfully transferring crypto currency on a social network 30. The frequency of send attempts before requesting verification 6 shall be set by the user 7a7b and/or the system. The volume of crypto currency one can send before verification 6 can also be set 23. A user can turn off all features 624*, or enable all of them for maximum security 23. The adjustment of these options 624*23 can be also be protected by another form of verification 624*23 to ensure that nobody but the user 7a7b can change their own security parameters 23.

Methods of verification 6 can include a mobile authenticator 24a; running as an application which generates a different unique code during each interval of an increment of time. The user 7a7b then inputs this temporary code into an interface 25a25b, thus verifying that the user 7a7b is in possession of the device which was paired with the crypto currency wallet send address 1a2b. A security token used to validate a crypto currency transaction occurring between users on a social networking site 30. A secure password or pass phrase 24b can be entered to the social network crypto currency transaction interface 25a25b. The password 24b is different from the encrypted password 11 belonging to the wallet 1a2b. Submission of the correct password or pass phrase 24b prompts the initiation of a crypto currency transaction process 30 occurring on a social network platform or other internet communication technology.

The user 7a7b can select an image verification option 24c to authorize a crypto currency transfer 30 in which an image is chosen by the user 7a7b during the initial setup phase 23, and later displayed amongst an array of images in which selecting the correct image, established from before, proves as verification 6 for initiating a crypto currency transaction 30. Furthermore, the image verification process 24c can be expanded upon by the user 7a7b first selecting a security question and then typing the answer. The answer is then rendered into a captcha image which appears in an array of other captcha images. Selecting the correct captcha image serves as verification 6 for initiating a crypto currency transaction 30. Finally, the image verification process 24c to authorize a crypto currency transfer 30 incorporates traditional captcha systems in which the user verifies 6 that they are human by filling out a captcha form 24c.

Methodology for verification 6 of a crypto currency transaction occurring over a social network platform 30 in which voice recognition is utilized 24d: A recording of the user's voice can be stored in a database and matched against the user while performing a similar sound frequency 24d. An approximate match serves to verify the initiation to transfer crypto currency 24d. Retinal, finger print, DNA analysis or other physical attribute unique to the user shall be matched to validate the authenticity of a user's identity 24e as a means to verify 6 an initiation of crypto currency transfer 30.

Upon initiating a transaction of crypto currency on a social network 30, e-mail confirmation is sent to an email address 24f. The body, title or message of the email contains information specific or relevant to an initiated crypto currency transaction 30. Clicking a link, entering a response or otherwise performing any verification task 6 included within the body, title or message of the e-mail confirms the verification 24f of the initiation to transfer crypto currency 30. Upon successful verification 6, the crypto currency then leaves the sender's wallet 1a30. The same methodology applies to an instant message, phone call or other communication process in which the information reaches the user 7a7b from within the social network platform 4a4b25a25b or outside of the social network platform where fulfillment of the process 6 grants permission to transact crypto currency 30.

A user 7a7b can select a security question or author a security question 24g, and provide an answer to the security question. The question & answer pair are stored in a database. The security question shall then be presented at any point between the initiation of sending crypto currency 30 and the confirmation of the transaction 12. Providing the accurate answer to the question shall serve as a verification process 6 for granting permission for the transfer of crypto currency 30. The aforementioned descriptions of verification methods 6, their appearance, sequence, insertion in the process or intended integration are interchangeable and can serve as verification 6 for any step during any process within the methodology of transferring crypto currency 30 between users 7a7b of a social network or other internet based communication service.

Although particular embodiments of the invention have been shown and described in full here, there is no intention to thereby limit the invention to the details of such embodiments. On the contrary, the intention is to cover all modifications, alternatives, embodiments, usages and equivalents of the subject invention as fall within the spirit and scope of the invention, specification, and the appended claims.

What is claimed is:

1. A method for transferring cryptocurrency between users on a social network, the method comprising the following steps:
creating online accounts of a social network for one or more users using internet capable devices wherein said creating using one or more secure servers;
logging in to said online accounts by said one or more users;
encountering or otherwise interacting with other users over the social network using said online accounts;
providing a cryptocurrency transaction between said users using said online accounts; and generating profit from any phase of the transaction.

2. The method according to claim 1, further comprising the step using private credentials or encryption measures, which for all intents and purposes, are unique to each said user for logging in to their said online accounts wherein said private credentials are either same, similar, different or none of or additional encryption measures shall be used to initiate or authorize a cryptocurrency transaction on said online accounts by said one or more users.

3. The method according to claim 1, further comprising the step using private credentials or encryption measures, which are unique to each said user for logging in to their said online accounts wherein said private credentials are either same, similar, different or none of or additional encryption measures are used to initiate or authorize a cryptocurrency transaction on said online accounts by said one or more users.

4. The method according to claim 1 wherein said encounters and interactions between said users may be any combination of interface components selected from the group of features; scannable pictures; text; video and language.

5. The method according to claim 1 wherein one or more wallets or an interface representing any number of digital wallets are provided to said users in which each individual wallet contains a series of key codes representing the sending and receiving addresses unique to said users or said online account's individual wallets; wherein said digital wallets are managed by either a 3rd party entity, any entity representing said social network itself or the users themselves; and wherein any number of security measures or verification processes are implemented by said 3rd party entity, said entity representing said social network platform and/or said users themselves.

6. The method according to claim 1 wherein said users must each be in possession of or provided with one or more digital wallets, or an interface representing any number of digital wallets, in which each individual wallet contains a series of key codes representing the sending and receiving addresses unique to said users or said online account's individual wallets and wherein said digital wallets are managed separately by either a 3rd party entity or any entity representing said social network itself; and wherein any number of security measures or verification processes are implemented by said 3rd party entity or entity.

7. The method according to claim 1 wherein said users must each be in possession of or provided with one or more digital wallets, or an interface representing any number of digital wallets, in which each individual wallet contains a series of key codes representing the sending and receiving addresses unique to said users or said online account's individual wallets wherein said sending address is utilized on an internet connected device to initiate a transfer of cryptocurrency to a receiving address in order for said cryptocurrency transaction to occur wherein said sending address is a private address and said receiving address can be either a public address or private address.

8. The method according to claim 1 wherein said users are provided with a digital wallet or an interface representing a digital wallet, said digital wallet containing a key code which represents either a sending or receiving address unique to said user's individual wallet; wherein said private sending address is utilized on an internet connected device to initiate a transfer of cryptocurrency to a receiving address in order for said cryptocurrency transaction to occur; wherein said sending address is a private address, said receiving address is a public or private address and wherein said wallet; wallet management and wallet reporting features are all linked to and represented on an interface of a social network account.

9. The method according to claim 1 wherein said users must each be in possession of or provided with a digital wallet, or an interface representing a digital wallet, containing a key code which represents either a sending or receiving address unique to said user's individual wallet; wherein said private sending address is utilized on an internet connected device to initiate a transfer of cryptocurrency to a receiving address in order for said cryptocurrency transaction to occur; wherein said sending address is a private address, said receiving address is a public or private address and wherein said wallet; wallet management and wallet reporting features are all linked to and represented on an interface of a social network account wherein a first user initiates a transfer or any series of transfers of a specified payment amount directly to one or more other users utilizing functionality of a social networking platform.

10. The method according to claim 1 wherein said users must each be in possession of or provided with a digital wallet, or an interface representing a digital wallet, containing a key code which represents either a sending or receiving address unique to said user's individual wallet; wherein said private sending address is utilized on an internet connected device to initiate a transfer of cryptocurrency to a receiving address in order for said cryptocurrency transaction to occur; wherein said sending address is a private address, said receiving address is a public or private address and wherein said wallet; wallet management and wallet reporting features are all linked to and represented on an interface of a social network account wherein a first user initiates a transfer or any series of transfers of a specified payment amount directly to a second or more users utilizing functionality of a social networking platform; wherein a specified amount of cryptocurrency sent from said first user arrives in a single middle wallet or system of middle wallets; wherein said specified amount of cryptocurrency is stored within or transferred between said middle wallets for a specified duration while predetermined or otherwise specified conditions are completed to the satisfaction of any or all involved parties; wherein upon satisfactory completion of said durations and said conditions, part or whole of said transfer or series of transfers are sent from said middle wallets to one or more other users.

11. The method according to claim 1 wherein said users must each be in possession of or provided with a digital wallet, or an interface representing a digital wallet, containing a key code which represents either a sending or receiving address unique to said user's individual wallet; wherein said private sending address is utilized on an internet connected device to initiate a transfer of cryptocurrency to a receiving address in order for said cryptocurrency transaction to occur; wherein said sending address is a private address, said receiving address is a public or private address and wherein said wallet; wallet management and wallet reporting features are all linked to and represented on an interface of a social network account wherein a first user initiates a transfer or any series of transfers of a specified payment amount directly to a second or more users utilizing functionality of a social networking platform; wherein a specified amount of cryptocurrency sent from said first user arrives in a single middle wallet or system of middle wallets; wherein said specified amount of cryptocurrency is stored within or transferred between said middle wallets for a duration while predetermined or otherwise specified conditions are completed to the satisfaction of any or all involved parties; wherein upon satisfactory completion of said durations and said conditions, part or whole of said transfer or series of transfers are sent from said middle wallets to one or more other users wherein said duration or said conditions include but are not limited to any combination of: the extraction of a percentage or any other amount of cryptocurrency from said transfer amount for any purpose, such as a fee, the accruement of a specified quantity of cryptocurrency or equivalent monetary value, a manually configured, manually confirmed or otherwise automated verification process or series of verification processes are introduced or successfully completed, one or more encryption methods are utilized on one or any packets of information during said transfer; the status of said transfer is analyzed on the block chain, status of said transfer is recorded into a separate database and/or conditions and/or reports of said status are communicated to any said users.

12. The method according to claim 1 wherein said users must each be in possession of or provided with one or more digital wallets, or an interface representing any number of digital wallets, in which each individual wallet contains a series of key codes representing the sending and receiving addresses unique to said users or said online account's individual wallets; wherein said digital wallets are procured by or managed separately by either a 3rd party entity representing said social network platform or any entity representing said social network itself; and wherein any number of security measures or verification processes are implemented by said 3rd party entity or entity representing said social network platform wherein possession, ownership or access to any attributes of said digital wallet itself may be transferred in part or in whole between one or more said users utilizing functionality of a social network platform, said 3rd party or said entity.

13. The method according to claim 1 wherein said users must each be in possession of or provided with one or more digital wallets in which each wallet contains a series of key codes represent sending and receiving addresses unique to said users or said online account's individual wallets wherein said users can make deposits and withdrawals of cash, monetary value or cryptocurrency to and from said wallet utilizing functionality of a secure wallet and transaction interface or interface comprising of features implemented on a social network platform.

14. The method according to claim 1 wherein said encounters and interactions between said users may be any combination of interface components selected from the group of features; scannable pictures; text; video and language wherein said components, features, scannable items, pictures, videos or language can be configured by said users to display any configuration of request to send or receive cryptocurrency for all intents and purposes; wherein activation of said components by a user can initiate any phase of the transfer process and said components can be labeled or otherwise aesthetically categorized to represent any specific variables or conditions of said transfer and wherein said components are linked to or represented on a social networking platform.

15. The method according to claim 1 wherein said users must each be in possession of or provided with a digital wallet, or an interface representing a digital wallet, containing a key code which represents either a sending or receiving address unique to said user's individual wallet; wherein said private sending address is utilized on an internet connected device to initiate a transfer of cryptocurrency to a receiving address in order for said cryptocurrency transaction to occur; wherein said sending address is a private address, said receiving address is a public or private address and wherein said wallet; wallet management and wallet reporting features are all linked to and represented on an interface of a social network account wherein a first user initiates a transfer or any series of transfers of a specified payment amount directly to a second or more users utilizing functionality of a social networking platform; wherein a specified amount of cryptocurrency sent from said first user arrives in a single middle wallet or system of middle wallets; wherein said specified amount of cryptocurrency is stored within or transferred between said middle wallets for a duration while predetermined or otherwise specified conditions are completed to the satisfaction of any or all involved parties; wherein upon satisfactory completion of said durations and said conditions, part or whole of said transfer or series of transfers are sent from said middle wallets to one or more other users wherein said duration or said conditions include but are not limited to any combination of: the extraction of a percentage or any other amount of cryptocurrency from said transfer amount for any purpose, such as a fee, the accruement of a specified quantity of cryptocurrency or equivalent monetary value, a manually configured, manually confirmed or otherwise automated verification process or series of verification processes are introduced or successfully completed, one or more encryption methods are utilized on one or any packets of information during said transfer or the status of said transfer is analyzed on the block chain, status of said transfer is recorded into a separate database and/or conditions and/or reports of said status are communicated to any said users; wherein one or more of said durations and conditions can be applied by a 3rd party, entity representing a social network platform or said users themselves to any said transfer or series of transfers wherein a first user initiates said transfers directly to one or more other users without implementation of said middle wallet or said system of middle wallets.

16. The method according to claim 1 wherein said users must each be in possession of or provided with a digital wallet, or an interface representing a digital wallet, containing a key code which represents either a sending or receiving address unique to said user's individual wallet; wherein said private sending address is utilized on an internet connected device to initiate a transfer of cryptocurrency to a receiving address in order for said cryptocurrency transaction to occur; wherein said sending address is a private address, said receiving address is a public or private address and wherein said wallet; wallet management and wallet reporting features are all linked to and represented on an interface of a social network account wherein a first user initiates a transfer or any series of transfers of a specified payment amount directly to a second or more users utilizing functionality of a social networking platform; wherein a specified amount of cryptocurrency sent from said first user arrives in a single middle wallet or system of middle wallets; wherein said specified amount of cryptocurrency is stored within or transferred between said middle wallets for a specified duration while predetermined or otherwise specified conditions are completed to the satisfaction of any or all involved parties; wherein upon satisfactory completion of said durations and said conditions, part or whole of said transfer or series of transfers are sent from said middle wallets to said second user; whereas failure to satisfy said conditions shall result in said transfer or series of transfers returned from said middle wallet to said first user.

17. The method according to claim 1 wherein one or more wallets or an interface representing any number of digital wallets are in possession of said users in which each individual wallet contains a series of key codes representing the sending and receiving addresses unique to said users or said online account's individual wallets; wherein said digital wallets are procured by or managed by either a 3rd party entity, any entity representing said social network itself or the users themselves; and wherein any number of security measures or verification processes are implemented by said 3rd party entity, said entity representing said social network platform or said users themselves.

18. The method according to claim 1 wherein said users in possession of a digital wallet or an interface representing a digital wallet containing a key code which represents either a sending or receiving address unique to said user's individual wallet and wherein said private sending address is utilized on an internet connected device to initiate a transfer of cryptocurrency to a receiving address in order for said cryptocurrency transaction to occur and wherein said sending address is a private address, said receiving address is a public or private address and wherein said wallet and wherein wallet management and wallet reporting features are all linked to and represented on an interface of a social network account.

19. The method according to claim 1, further comprising the step using private credentials or encryption measures, which are unique to each said user for logging in to their said online accounts wherein said private credentials are either same, similar, different or additional encryption measures are used to initiate or authorize a cryptocurrency transaction on said online accounts by said one or more users wherein said private credentials may be any combination of selected from a user name, password, image verification, security question answer, email address, random number generator, algorithm, body part recognition, or voice recognition.

20. The method according to claim 1 wherein said users must each be in possession of or provided with a digital wallet, or an interface representing a digital wallet, containing a key code which represents either a sending or receiving address unique to said user's individual wallet; wherein said private sending address is utilized on an internet connected device to initiate a transfer of cryptocurrency to a receiving address in order for said cryptocurrency transaction to occur; wherein said sending address is a private address, said receiving address is a public or private address and wherein said wallet; wallet management and wallet reporting features are all linked to and represented on an interface of a social network account wherein said users shall gain access to said wallets and said features on a mobile device, tablet, cell phone, desk top computer, lap top computer, bodily-integrated apparatus, cloud network, website, mobile application, or within a virtual space.
